(19) United States
(12) Patent Application Publication
(10) Pub. No.: US 2024/0378899 A1
(43) Pub. Date: Nov. 14, 2024

(54) VISION-BASED SYSTEM TRAINING WITH SIMULATED CONTENT

(71) Applicant: Tesla, Inc., Austin, TX (US)

(72) Inventors: David Abfall, Austin, TX (US); Michael Hosticka, Austin, TX (US)

(73) Assignee: Tesla, Inc., Austin, TX (US)

(21) Appl. No.: 18/684,607

(22) PCT Filed: Aug. 18, 2022
(86) PCT No.: PCT/US2022/040793

§ 371 Date: Feb. 16, 2024

Related U.S. Application Data
(60) Provisional application No. 63/260,439, filed on Aug. 19, 2021.
(60) Provisional application No. 63/287,936, filed on Dec. 9, 2021.

(51) Int. Cl. G06V 20/56; G06T 7/13; G06V 20/70

(52) U.S. Cl. CPC G06V 20/588; G06T 7/13; G06V 20/70

(57) ABSTRACT

Aspects of the present application correspond to utilization of a combined set of inputs from simulation systems to generate or train machine learned algorithms for utilization in vehicles with vision system-only based processing. Aspects of the present application correspond to utilization of a set of inputs from sensors or sensing systems and simulation systems to create updated training sets for use in machine learning algorithms. The combined set of inputs includes a first set of data corresponding to vision system from a plurality of cameras configured in a vehicle. The combined set of inputs further includes a second set of data corresponding to simulated content systems that generate additional training set data including visual images and data labels to supplement the vision system data.

### CROSS-REFERENCE TO RELATED APPLICATIONS

This application claims priority to U.S. Provisional Application No. 63/260,439 entitled ENHANCED SYSTEMS AND METHODS FOR AUTONOMOUS VEHICLE OPERATION AND TRAINING and filed on Aug. 19, 2021, and U.S. Provisional Application No. 63/287,936 entitled ENHANCED SYSTEMS AND METHODS FOR AUTONOMOUS VEHICLE OPERATION AND TRAINING and filed on Dec. 9, 2021. U.S. Provisional Application Nos. 63/260,439 and 63/287,936 are incorporated by reference in its entire herein.

### BACKGROUND

Generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet).

Generally described, a variety of vehicles, such as electric vehicles, combustion engine vehicles, hybrid vehicles, etc., can be configured with various sensors and components to facilitate operation of the vehicle or management of one or more systems include in the vehicle. In certain scenarios, a vehicle owner or vehicle user may wish to utilize sensor-based systems to facilitate in the operation of the vehicle. For example, vehicles can often include hardware and software functionality that facilitates location services or can access computing devices that provide location services. In another example, vehicles can also include navigation systems or access navigation components that can generate information related to navigational or directional information provided to vehicle occupants and users. In still further examples, vehicles can include vision systems to facilitate navigational and location services, safety services or other operational services/components.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 depicts a block diagram of an illustrative environment for generating simulated content models and training set data for vision systems in vehicles in accordance with one or more aspects of the present application;

FIG. 2A illustrates an environment that corresponds to vehicles in accordance with one or more aspects of the present application;

FIG. 2B an illustrative vision system for a vehicle in accordance with one or more aspects of the present application;

FIG. 3A depicts an illustrative architecture for implementing a vision information processing component in accordance with aspects of the present application,

FIG. 3B depicts an illustrative architecture for implementing a simulated content service in accordance with aspects of the present application;

FIGS. 4A-4C are block diagrams of the illustrative environment of FIG. 1 illustrated the generation of simulated model content and the subsequent generation of a set of vision system training data for machine learning algorithms based on simulate model content;

FIG. 5 is a flow diagram illustrative of a simulated model content generation routine implemented by a simulated content service in accordance with illustrative embodiments; and

FIG. 6 is a flow diagram illustrative of a vision system training data generation routine based on simulated model content generation routine implemented by a simulated content service in accordance with illustrative embodiments.

### DETAILED DESCRIPTION

Generally described, one or more aspects of the present disclosure relate to the configuration and implementation of vision systems in vehicles. By way of illustrative example, aspects of the present application relate to the configuration and training of machine learned algorithms used in vehicles relying solely on vision systems for various operational functions. Illustratively, the vision-only systems are in contrast to vehicles that may combine vision-based systems with one or more additional sensor systems, such as radar-based systems, LIDAR-based systems, SONAR-systems, and the like.

Vision-only systems can be configured with machine learned algorithms that can process inputs solely from vision systems that can include a plurality of cameras mounting on the vehicle. The machine learned algorithm can generate outputs identifying objects and specifying characteristics/attributes of the identified objects, such as position, velocity, acceleration measured relative to the vehicle. The outputs from the machine learned algorithms can be then utilized for further processing, such as for navigational systems, locational systems, safety systems and the like.

In accordance with aspects of the present application, a network service can configure the machine learned algorithm in accordance with a supervised learning model in which a machine learning algorithm is trained with labeled data including identified objects and specified characteristics/attributes, such as position, velocity, acceleration, and the like. A first portion the training data set corresponds to data collected from target vehicles that include vision systems, such as the vision systems included in the vision-only system in the vehicles. Additionally, a second portion of the training data corresponds to additional information obtained from other systems, namely, a simulated content system that can generate video images and associated attribute information (e.g., ground truth label data based on the simulated content). Illustratively, the simulated content system can process at least the ground truth label data (or a portion thereof) from the captured vision system data to generate simulated content with associated ground truth labeling information for use in training sets for the supervised learning models.

Illustratively, a network service can receive a set of inputs (e.g., a first data set) from a target vehicle including ground truth label data associated with captured vision system data. In one embodiment, the first data set does not have to include the captured video data, but can include resulting ground truth label associated with the captured video data. The network service then processes at least the ground truth label data associated with the captured vision system data to determine content model attributes that will be used to generate a set of simulated content (e.g., a second data set). For example, the content model attributes may be limited to a selection from the set of received ground truth information associated with specific types of ground truth labels, such as road edges. In another example, the content model attributes can include the ground truth labels, such as road edges, and include additional dependent ground truth labels, such as lane lines, center lanes, etc.

Illustratively, the generated simulated content data sets allows the supplementing of the previously collected ground truth data/vision data with additional information or attribute/characteristics that may not have been otherwise available from processing the vision data. In one aspect, once the selected subset of ground truth labels have been selected, the simulated content service can select from generic templates to compliment/supplement the ground truth labels. For example, the simulated content service can select from templates of ground truth labels, such as cityscapes (e.g., a generic city environment or rural environment), environmental objects (e.g., different types of stationary objects), etc. Additionally, the simulated content can include modified or altered ground truth label information. The resulting processed content attributes can then form the basis for subsequent generation of training data.

Illustratively, the simulated content service can receive requests or determine to generate a set of training data for an updated training set. The simulated content service can identify and utilize one of the generated content models as the basis for creating multiple variations based on the selected content model. The resulting simulated content includes the ground truth labels data including the ground truth labels based on the base content model and the variations depicted in each created piece of content. Thereafter, the network service generates an updated machine learned algorithm based on training on the combined data set. The trained machine learned algorithm may be transmitted to vision-only based vehicles.

Traditionally, vehicles are associated with physical sensors that can be used to provide inputs to control components. For many navigational, location and safety system, the physical sensors include detection-based systems, such as radar systems, LIDAR systems, etc. that are able to detect objects and characterize attributes of the detected objects. In some applications, detection systems can increase the cost of manufacture and maintenance. Additionally, in some environmental scenarios, such as rain, fog, snow, the detection-based systems may not be well suited for detection or can increase detection errors.

To address at least a portion of the above deficiencies, aspects of the present application correspond to utilization of a set of inputs from vision systems so that simulation systems can generate additional content for training machine learned algorithms. For example, the updated trained machine learned algorithms can be distributed to vehicles with vision system-only based processing. Aspects of the present application correspond to utilization of a set of inputs from sensors or sensing systems and simulation systems as the basis for a simulation system to create updated training sets for use in machine learning algorithms. The set of inputs includes a first set of data corresponding to vision system from a plurality of cameras configured in a vehicle. The first set of data can include visual images and data labels (e.g., ground truth labels). The ground truth labels can include various detected objects, such as lane edges, center lanes, static objects, and dynamic objects. In some embodiments, the first set of data can include the ground truth label data base don the captured visual image data without need to provide the captured video image data. The ground truth label information may be provided by additional, independent services that can process the captured visual data provided by vehicle vision systems to generate ground truth label data.

Illustratively, a network service can receive the process the set of inputs (e.g., the associated ground truth label data) collected from one or more target vehicles. The network service can then process the vision-based data to form the content model attributes that will be used as the basis or core portion of the simulated content. For example, the content model attributes can include/select at least an initial portion (e.g., a first portion) of the provided ground truth label information corresponding the road edges. The network service can then also include/select some portion of the additional ground truth label information (e.g., a second portion) that can be included in the simulated content. Such second portion can include center lane, lane lines, stationary objects, etc. The network service (e.g., a simulated content service) can also supplement or replace the obtained ground truth information based on templates or other pre-configured ground truth labels to be included. For example, a filtered set of ground truth label data corresponding to a suburban setting may be supplemented with a template of ground truth labels for objects characterized as associated with such suburban settings, such as trees, houses, parked vehicles, etc.

Upon request or other triggering event, the network service can select one or content models to use to generate a set of training data based on variations of the content model(s). For example, the above content model related to the suburban setting can be used to generate simulated content and associated ground truth labels based on variations associated with types of stationary objects, dynamic objects (e.g., other vehicles), weather conditions, obstructions, various signage, and the like. Illustratively, the generated data sets allows the supplementing of the previously collected vision data with additional information or attribute/characteristics that may not have been otherwise available from processing the vision data. The network service can then process the full set of vision data and generated content with data labels. Thereafter, the network service generates an updated machine learned algorithm based on training on the combined data set. The trained machine learned algorithm may be transmitted to vision-only based vehicles.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of vehicles including vehicles with different of propulsion systems, such as combination engines, hybrid engines, electric engines, and the like. Still further, aspects of the present application may be applicable with various types of vehicles that can incorporate different types of sensors, sensing systems, navigation systems, or location systems. Accordingly, the illustrative examples should not be construed as limiting. Similarly, aspects of the present application may be combined with or implemented with other types of components that may facilitate operation of the vehicle, including autonomous driving applications, driver convenience applications and the like.

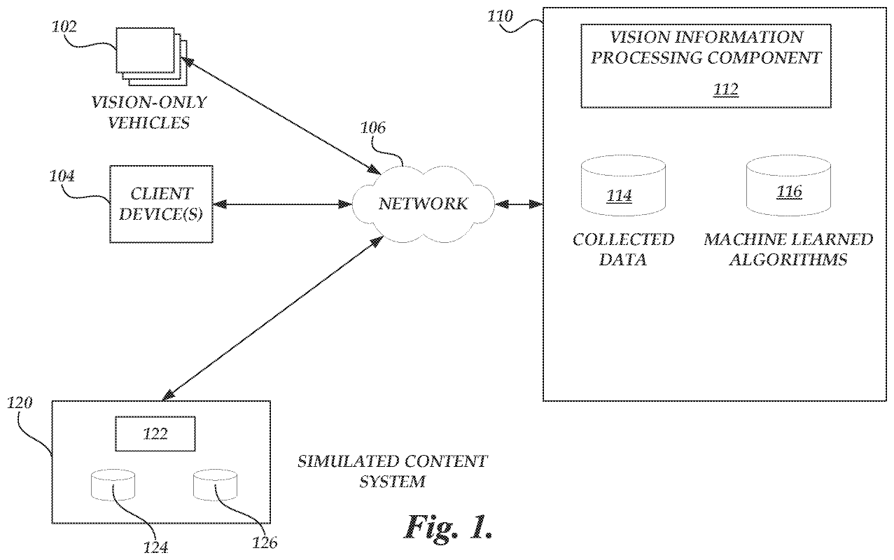

FIG. 1 depicts a block diagram of an illustrative environment 100 for generating simulated content models and training set data for vision systems in vehicles in accordance with one or more aspects of the present application. The system 100 can comprise a network, the network connecting a set of vehicles 102, a network service 110, and a simulated content system 120. Illustratively, the various aspects associated with the network service 110 and simulated content system 120 can be implemented as one or more components that are associated with one or more functions or services. The components may correspond to software modules implemented or executed by one or more external computing devices, which may be separate stand-alone external computing devices. Accordingly, the components of the network service 110 and the simulated content system 120 should be considered as a logical representation of the service, not requiring any specific implementation on one or more external computing devices.

Network 106, as depicted in FIG. 1, connects the devices and modules of the system. The network can connect any number of devices. In some embodiments, a network service provider provides network-based services to client devices via a network. A network service provider implements network-based services and refers to a large, shared pool of network-accessible computing resources (such as compute, storage, or networking resources, applications, or services), which may be virtualized or bare-metal. The network service provider can provide on-demand network access to a shared pool of configurable computing resources that can be programmatically provisioned and released in response to customer commands. These resources can be dynamically provisioned and reconfigured to adjust to the variable load. The concept of “cloud computing” or “network-based computing” can thus be considered as both the applications delivered as services over the network and the hardware and software in the network service provider that provide those services. In some embodiments, the network may be a content delivery network.

Illustratively, the set of vehicles 102 correspond to one or more vehicles configured with vision-only based system for identifying objects and characterizing one or more attributes of the identified objects. The set of vehicles 102 are configured with machine learned algorithms, such as machine learned algorithms implemented a supervised learning model, that are configured to utilize solely vision systems inputs to identify objects and characterize attributes of the identified objects, such as position, velocity and acceleration attributes. The set of vehicles 102 may be configured without any additional detection systems, such as radar detection systems, LIDAR detection systems, and the like.

Illustratively, the network service 110 can include a plurality of network-based services that can provide functionality responsive to configurations/requests for machine learned algorithms for vision-only based systems as applied to aspects of the present application. As illustrated in FIG. 1, the network-based services 110 can include a vision information processing component 112 that can obtain data sets from the vehicles 102 and the simulated content systems 120, process sets of data to form training materials for machine learning algorithm and generate machine learned algorithms for vision-only based vehicles 102. The network-based service can include a plurality of data stores for maintaining various information associated with aspects of the present application, including a vehicle data store 114 and machine learned algorithm data store 116. The data stores in FIG. 1 are logical in nature and can be implemented in the network service 110 in a variety of manners.

Similar to network service 110, the simulated content service 120 can include a plurality of network-based services that can provide functionality related to providing visual frames of data and associated data labels for machine learning applications as applied to aspects of the present application. As illustrated in FIG. 1, the network-based services 120 can include a scenario generation component 122 that can create various simulated content scenarios according to a set of defined attributes/variables. The simulated content service 120 can include a plurality of data stores for maintaining various information associated with aspects of the present application, including a scenario clip data store 124 and ground truth attribute data store 126. The data stores in FIG. 1 are logical in nature and can be implemented in the simulated content service in a variety of manners.

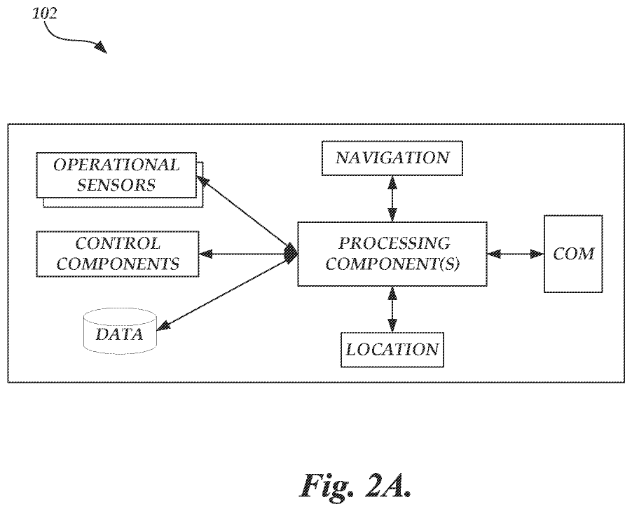

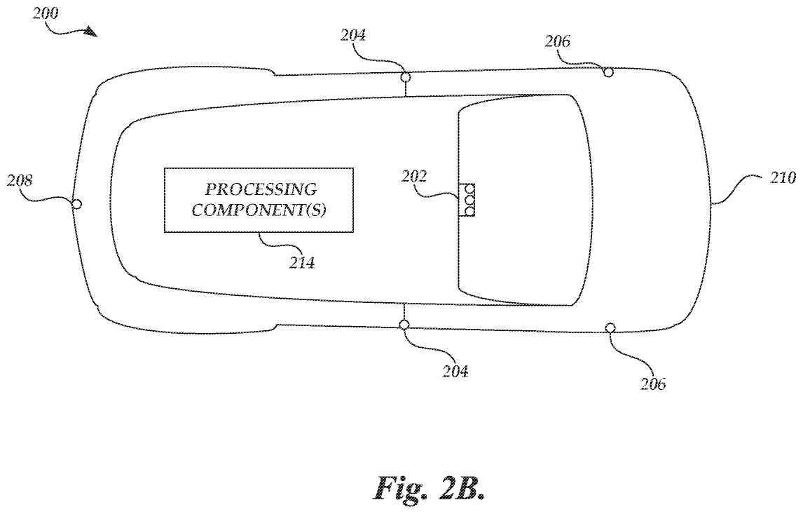

For purposes of illustration, FIG. 2A illustrates an environment that corresponds to vehicles 102 in accordance with one or more aspects of the present application. The environment includes a collection of local sensor inputs that can provide inputs for the operation of the vehicle or collection of information as described herein. The collection of local sensors can include one or more sensor or sensor-based systems included with a vehicle or otherwise accessible by a vehicle during operation. The local sensors or sensor systems may be integrated into the vehicle. Alternatively, the local sensors or sensor systems may be provided by interfaces associated with a vehicle, such as physical connections, wireless connections, or a combination thereof.

In one aspect, the local sensors can include vision systems that provide inputs to the vehicle, such as detection of objects, attributes of detected objects (e.g., position, velocity, acceleration), presence of environment conditions (e.g., snow, rain, ice, fog, smoke, etc.), and the like. An illustrative collection of cameras mounted on a vehicle to form a vision system will be described with regard to FIG. 2B. As previously described, vehicles 102 will rely on such vision systems for defined vehicle operational functions without assistance from or in place of other traditional detection systems.

In yet another aspect, the local sensors can include one or more positioning systems that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle, specifically elevation at a current location. In other embodiments, the positioning systems can also determine travel-related operational parameters, such as direction of travel, velocity, acceleration, and the like. The positioning system may be configured as part of a vehicle for multiple purposes including self-driving applications, enhanced driving or user-assisted navigation, and the like. Illustratively, the positioning systems can include processing components and data that facilitate the identification of various vehicle parameters or process information.

In still another aspect, the local sensors can include one or more navigations system for identifying navigation related information. Illustratively, the navigation systems can obtain positioning information from positioning systems and identify characteristics or information about the identified location, such as elevation, road grade, etc. The navigation systems can also identify suggested or intended lane location in a multi-lane road based on directions that are being provided or anticipated for a vehicle user. Similar to the location systems, the navigation system may be configured as part of a vehicle for multiple purposes including self-driving applications, enhanced driving or user-assisted navigation, and the like. The navigation systems may be combined or integrated with positioning systems. Illustratively, the positioning systems can include processing components and data that facilitate the identification of various vehicle parameters or process information.

The local resources further include one or more processing component(s) that may be hosted on the vehicle or a computing device accessible by a vehicle (e.g., a mobile computing device). The processing component(s) can illustratively access inputs from various local sensors or sensor systems and process the inputted data as described herein. For purposes of the present application, the processing component(s) will be described with regard to one or more functions related to illustrative aspects. For example, processing component(s) in vehicles 102 will collect and transmit the first data set corresponding to the collected vision information.

The environment can further include various additional sensor components or sensing systems operable to provide information regarding various operational parameters for use in accordance with one or more of the operational states. The environment can further include one or more control components for processing outputs, such as transmission of data through a communications output, generation of data in memory, transmission of outputs to other processing components, and the like.

With reference now to FIG. 2B, an illustrative vision system 200 for a vehicle will be described. The vision system 200 includes a set of cameras that can capture image data during the operation of a vehicle. As described above, individual image information may be received at a particular frequency such that the illustrated images represent a particular time stamp of images. In some embodiments, the image information may represent high dynamic range (HDR) images. For example, different exposures may be combined to form the HDR images. As another example, the images from the image sensors may be pre-processed to convert them into HDR images (e.g., using a machine learning model).

As illustrated in FIG. 2B, the set of cameras can include a set of front facing cameras 202 that capture image data. The front facing cameras may be mounted in the windshield area of the vehicle to have a slightly higher elevation. As illustrated in FIG. 2B, the front facing cameras 202 can including multiple individual cameras configured to generate composite images. For example, the camera housing may include three image sensors which point forward. In this example, a first of the image sensors may have a wide-angled (e.g., fish-eye) lens. A second of the image sensors may have a normal or standard lens (e.g., 35 mm equivalent focal length, 50 mm equivalent, and so on). A third of the image sensors may have a zoom or narrow lens. In this way, three images of varying focal lengths may be obtained in the forward direction by the vehicle. The vision system 200 further includes a set of cameras 204 mounted on the door pillars of the vehicle. The vision system 200 can further include two cameras 206 mounted on the front bumper of the vehicle. Additionally, the vision system 200 can include a rearward facing camera 208 mounted on the rear bumper, trunk or license plate holder.

The set of cameras 202, 204, 206, and 208 may all provide captured images to one or more processing components 212, such as a dedicated controller/embedded system. For example, the processing component 212 may include one or more matrix processors which are configured to rapidly process information associated with machine learning models. The processing component 212 may be used, in some embodiments, to perform convolutions associated with forward passes through a convolutional neural network. For example, input data and weight data may be convolved. The processing component 212 may include a multitude of multiply-accumulate units which perform the convolutions. As an example, the matrix processor may use input and weight data which has been organized or formatted to facilitate larger convolution operations. Alternatively, the image data may be transmitted to a general-purpose processing component.

Illustratively, the individual cameras may operate, or be considered individually, as separate inputs of visual data for processing. In other embodiments, one or more subsets of camera data may be combined to form composite image data, such as the trio of front facing cameras 202. As further illustrated in FIG. 2B, in embodiments related to vehicles incorporating vision only systems, such as vehicles 102, no detection systems would be included at 210.

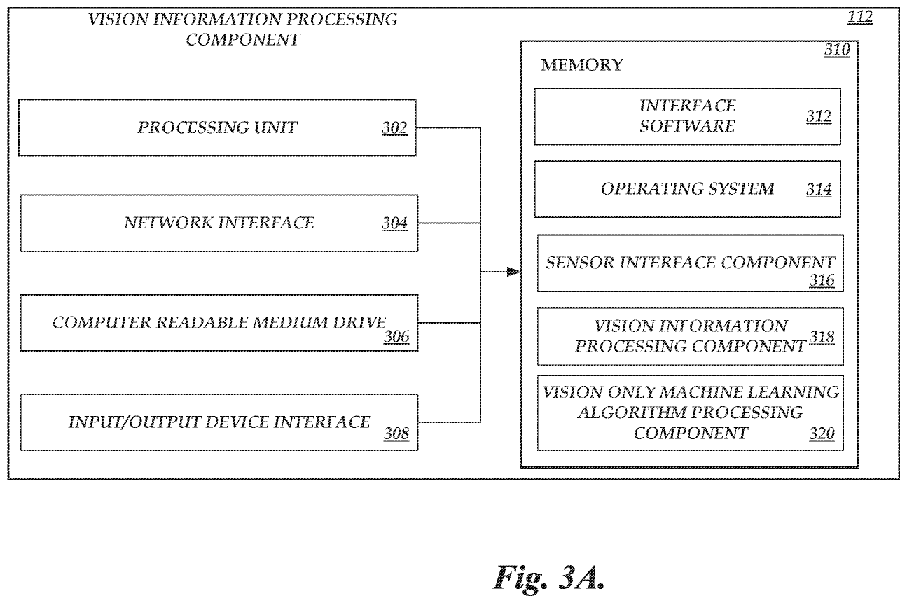

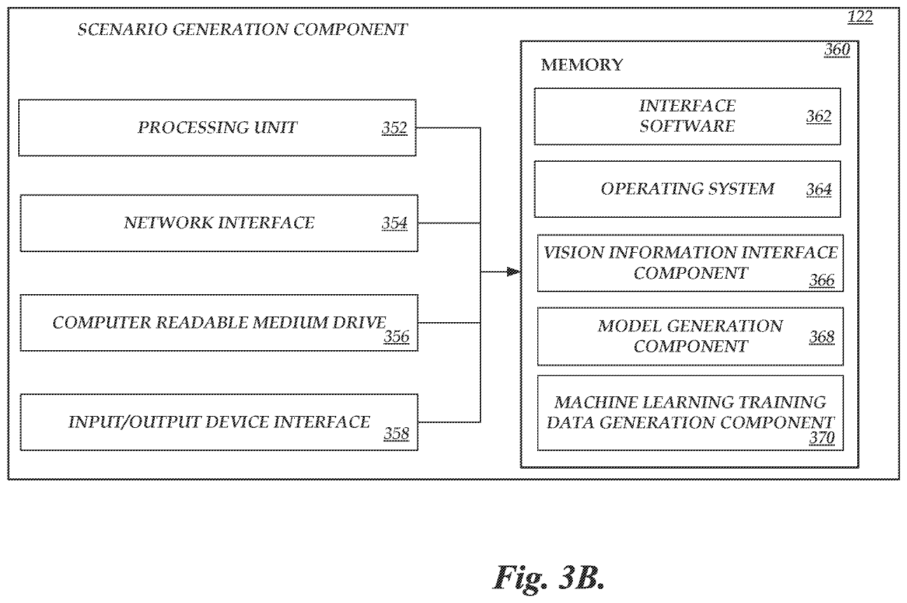

With reference now to FIG. 3A, an illustrative architecture for implementing the vision information processing component 112 on one or more local resources or a network service will be described. The vision information processing component 112 may be part of components/systems that provide functionality associated with the machine learned algorithms for object recognition, navigation, locations services, and the like.

The architecture of FIG. 3A is illustrative in nature and should not be construed as requiring any specific hardware or software configuration for the vision information processing component 112. The general architecture of the vision information processing component 112 depicted in FIG. 3A includes an arrangement of computer hardware and software components that may be used to implement aspects of the present disclosure. As illustrated, the vision information processing component 112 includes a processing unit 302, a network interface 304, a computer readable medium drive 306, and an input/output device interface 308, all of which may communicate with one another by way of a communication bus. The components of the vision information processing component 112 may be physical hardware components or implemented in a virtualized environment.

The network interface 304 may provide connectivity to one or more networks or computing systems, such as the network of FIG. 1. The processing unit 302 may thus receive information and instructions from other computing systems or services via a network. The processing unit 302 may also communicate to and from memory 310 and further provide output information for an optional display (not shown) via the input/output device interface 308. In some embodiments, the vision information processing component 112 may include more (or fewer) components than those shown in FIG. 3A.

The memory 310 may include computer program instructions that the processing unit 302 executes in order to implement one or more embodiments. The memory 310 generally includes RAM, ROM, or other persistent or non-transitory memory. The memory 310 may store interface software 312 and an operating system 314 that provides computer program instructions for use by the processing unit 302 in the general administration and operation of the vision information processing component 112. The memory 310 may further include computer program instructions and other information for implementing aspects of the present disclosure. For example, in one embodiment, the memory 310 includes a sensor interface component 316 that obtains information (e.g., captured video information) from vehicles, such as vehicles 102, data stores, other services, and the like.

The memory 310 further includes a vision information processing component 318 for obtaining and processing the captured vision system information and generating additional or alternative ground truth label information for the captured vision information in accordance with various operational states of the vehicle as described herein. The memory 310 can further include a vision-based machine learning algorithm processing component 320 for generating or training machine learned algorithms for use in vision-only based vehicles 102. Illustratively, in one embodiment, the vision-based machine learning algorithm processing component 320 can utilize sets of simulated content as training data as described herein. Although illustrated as components combined within the vision information processing component 112, one skilled in the relevant art will understand that one or more of the components in memory 310 may be implemented in individualized computing environments, including both physical and virtualized computing environments.

With reference now to FIG. 3B, an illustrative architecture for implementing a simulated content service 122 in accordance with aspects of the present application will be described. The simulated content service 122 may be part of components/systems that provide data, such as training data, associated with generating machine learned algorithms for object recognition, navigation, locations services, and the like.

The architecture of FIG. 3B is illustrative in nature and should not be construed as requiring any specific hardware or software configuration for the simulated content service 122. The general architecture of the simulated content service 122 depicted in FIG. 3B includes an arrangement of computer hardware and software components that may be used to implement aspects of the present disclosure. As illustrated, the v simulated content service 122 includes a processing unit 352, a network interface 354, a computer readable medium drive 356, and an input/output device interface 358, all of which may communicate with one another by way of a communication bus. The components of the simulated content service 122 may be physical hardware components or implemented in a virtualized environment.

The network interface 354 may provide connectivity to one or more networks or computing systems, such as the network of FIG. 1. The processing unit 352 may thus receive information and instructions from other computing systems or services via a network. The processing unit 352 may also communicate to and from memory 360 and further provide output information for an optional display (not shown) via the input/output device interface 358. In some embodiments, the simulated content service 122 may include more (or fewer) components than those shown in FIG. 3B.

The memory 360 may include computer program instructions that the processing unit 352 executes in order to implement one or more embodiments. The memory 360 generally includes RAM, ROM, or other persistent or non-transitory memory. The memory 360 may store interface software 362 and an operating system 364 that provides computer program instructions for use by the processing unit 352 in the general administration and operation of the simulated content service 122.

The memory 360 may further include computer program instructions and other information for implementing aspects of the present disclosure. For example, in one embodiment, the memory 360 includes a vision information interface component 366 that obtains vision system information from vehicles, such as vehicles 102, data stores, other services, and the like. The memory 360 further includes a model training component 368 for obtaining and processing the received vision system data or data labels (e.g., ground truth label data) and processing the vision system data in simulated content attribute data as described herein. The memory 360 can further include a vision-based machine learning algorithm processing component 370 for generating training data for machine learned algorithms for use in vision-only based vehicles 102.

Although illustrated as components combined within the simulated content service 122, one skilled in the relevant art will understand that one or more of the components in memory 310 may be implemented in individualized computing environments, including both physical and virtualized computing environments.

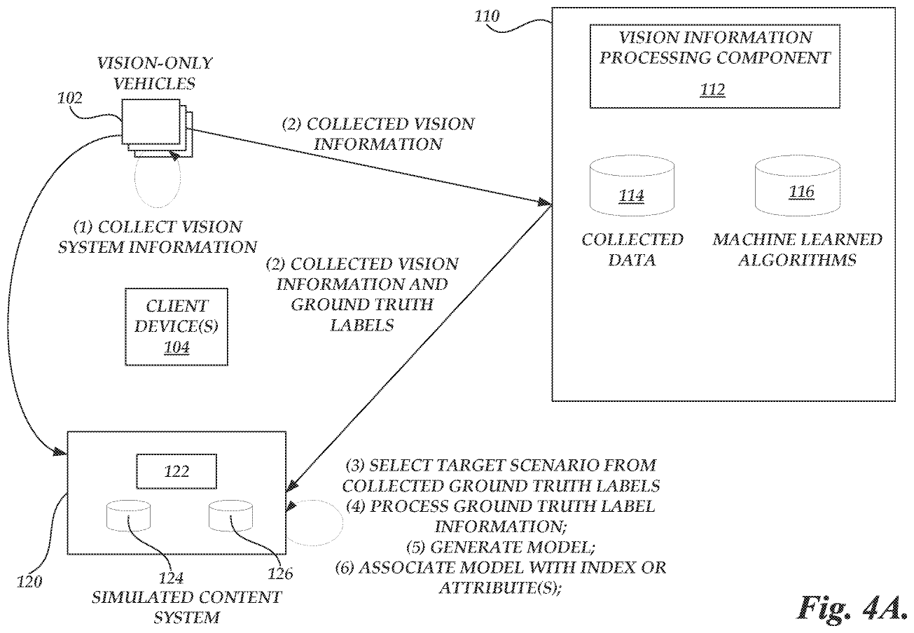

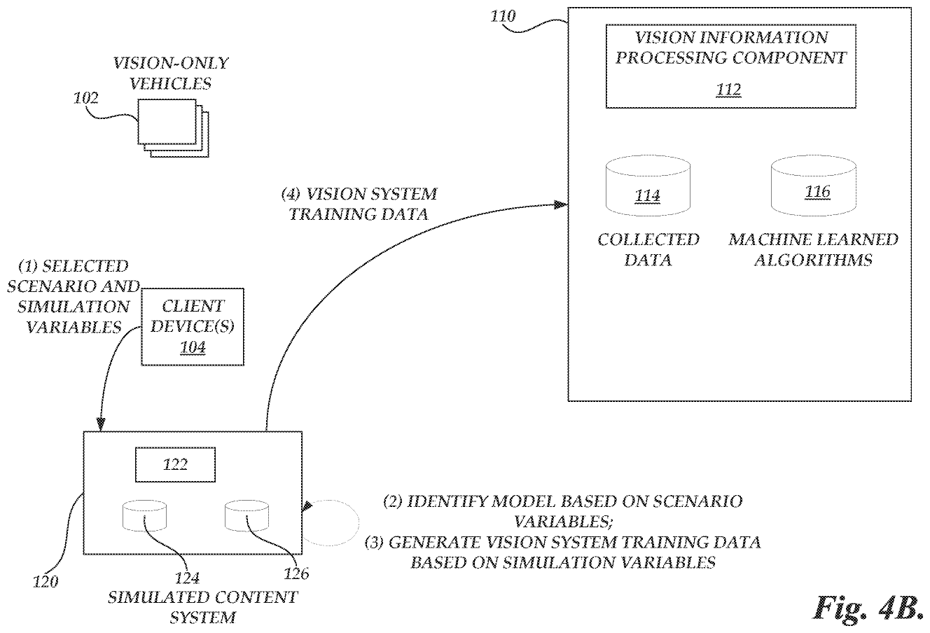

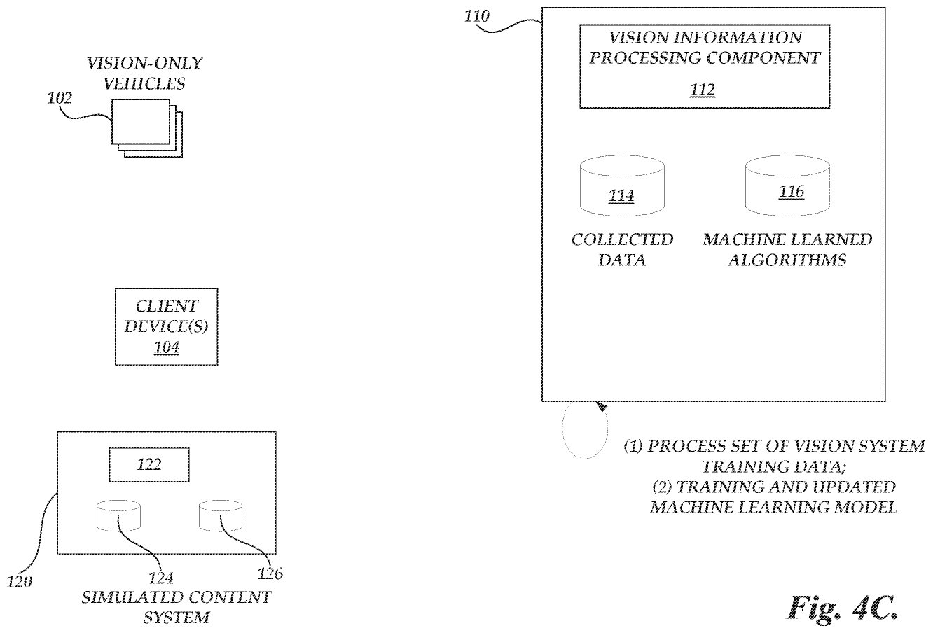

Turning now to FIGS. 4A-4C, illustrative interactions for the components of the environment to process vision system data and generate simulated content system data to update training models for machine learning algorithms will be described. At (1), one or more vehicles 102 can collect and transmit a set of inputs (e.g., the first data set). The first set of data illustratively corresponds to the video image data and any associated metadata or other attributes collected by the vision system 200 of the vehicle 102.

Illustratively, the vehicles 102 may be configured to collect vision system data and transmit the collected data. Illustratively, the vehicles 102 may include processing capabilities in vision systems to generate, at least in part, ground truth label information for the captured vision system information. In other embodiments, the vehicles 102 may transmit captured vision system information (with or without any ground truth labels) to another service, such as in the network 110. The additional services can then add (manually or automatically) ground truth label information. For example, the collected vision system data may be transmitted based on periodic timeframes or various collection/transmission criteria. Still further, in some embodiments, the vehicles 102 may also be configured to identify specific scenarios or locations, such as via geographic coordinates or other identifiers, that will result in the collection and transmission of the collected data. As shown in FIG. 4A, at (2), the collected vision system data may be transmitted to the simulated content service 122 directly from the vehicle 102 or indirectly through the network service 110.

At (3), the simulated content service 122 receives and processes the collected vision system data and ground truth labels from the vehicles 102. Illustratively, the simulated content service 122 can process the vision-based data, such as to complete lost frames of video data, update version information, error correction, and the like. Additionally, at (3), in some embodiments, the simulated content service 122 can further process the collected vision system data to identify ground truth labels for the captured video data. In still other embodiments, the simulated content service 122 can request or otherwise obtain missing or erroneous ground truth label information from additional sources. Illustratively, the ground truth labels can correspond to any one of a variety of detectable objects that may be depicted in the video data. In one embodiment, the ground truth label data can include information identifying road edges, which may have a higher priority or significance in the generation of the simulated content (as described in one illustrative embodiment). Additionally, the ground truth label data can include information dependent on the identified road edge, such as lane lines, lane centers, etc. and one or more stationary objects (e.g., road signs, markers, etc.). Still further, in some embodiments, the ground truth label data can include dynamic object data related to one or more identified objects, such as vehicles, dynamic obstructions, environmental objects, and the like. In some embodiments, the additional processing of the received vision data and ground truth label information as described at (3) may not be required.

At (4), the simulated content service 122 can process the ground truth label data for utilization in forming a content model for the simulated content. Illustratively, the simulated content service 122 can process the ground truth label according to a priority for identifying/extracting the core ground truth label data that will be used as the basis for the simulated content. Illustratively, the lane edge ground truth labels may be considered to have a high or higher priority. Additional ground truth label data, such as lane lines labels, lane center labels, static object labels, or dynamic object labels, may be associated with low or lower priority with regard to the lane label data or relative to each other. In some embodiments, the label data may be filtered to remove one or more labels (e.g., dynamic objects) that may be replaced by the simulated content or otherwise not required to generate simulated content. For purposes of illustrated, the processed set of ground truth label may be considered the content model attributes that will for the simulated content. Still further, in other embodiments, the simulated content service 122 can utilize pre-configured or templates of standardized ground truth label based on characteristics of the simulated content to be formed. For example, simulated content for vision information captured in an urban environment (e.g., business district) can utilize a template of stationary objects, buildings, signage, traffic lights, etc. that may be considered to be generically present in such a business district.

At (5), the simulated content service 122 generates the model for future generation of the simulated content. Illustratively, the simulated content service 122 can process the collected ground truth label data and prepare the set of ground truth labels for generating variations to form the set of simulated content as described herein. Such processing can include modifications for error adjustment, extrapolation, variation, and the like.

At (6), the simulated content service 122 can generate index data or attribute data (e.g., metadata) for each clip or simulated content data that will facilitate selection, sorting or maintenance of the data. The index or attribute data can include identification of the location, the types of objects simulated, the number of variations that are generated/available, environmental conditions simulated, tracking information, origin source information, and the like. For purposes of FIG. 4A, the simulated content may be generated without specific request/need for the scenarios for forming the training set, which will be described with regard to FIG. 4B.

Referring to FIG. 4B, illustratively, the stored and indexed simulated content information can be provided to the network service 110 as part of training data. At (1), the simulated content service 122 can receive a selection or criteria for selecting the content models (that will be generated or have been previously been generated). Illustratively, a computing device 104 may be utilized to provide criteria, such as sorting criteria. In some embodiments, the request for the simulated content is utilized to provide attributes of the simulated content. Accordingly, the generation of the simulated content can be considered to be responsive to the requests for simulated content in generating the simulated content itself. Thus, the generation of the simulated content may be considered synchronous in nature or dependent in nature. In other embodiments, the request may be a simple selectin of the index values or attributes such that the simulated content service 122 can generate the simulated content based on pre-configure attributes or configurations that are not dependent with the individual requests for simulated content. Accordingly, generation of the simulated content may be considered independent relative to the request.

At (2), the network service 110 can then process the requests and identifies the generated simulated content models, such as via index data. At (3), the simulated content service 122 generates supplemental video image data and associated attribute data. Illustratively, the simulated content system 120 can utilize a set of variables or attributes that can be changed to create different scenarios or scenes for use as supplemental content. For example, the simulated content system 120 can utilize color attributes, types of object attributes, acceleration attributes, action attributes, time of data attributes, location/position attributes, weather condition attributes, and density of vehicle attributes to create various scenarios related to an identified object. Illustratively, the supplemental content can be utilized to emulate real-world scenarios that may be less likely to occur or be measured by the set of vehicles 102. For example, the supplemental content can emulate various scenarios that would correspond to unsafe or hazardous conditions.

The simulated content system 120 may illustratively utilize a statistical selection of scenarios to avoid repetition based on trivial differences (e.g., similar scenarios varying only by color of object) that would otherwise have a potential to bias a machine learning algorithm. Additionally, the simulated content system simulated content service 122 to the number of supplemental content frames and distribution of differences in one or more variables. Illustratively, the output from the simulated content service 122 can include labels (e.g., ground truth information) identifying one or more attributes (e.g., position, velocity and acceleration) that can be detected or processed by the network service 110. In this regard, the simulated content data sets can facilitate detailed labels and can be dynamically adjusted as required for different machine learned training sets. At (4), the simulated content training sets are transmitted to the network service 110.

Turning now to FIG. 4C, once the network service 110 receives the training set, at (1) the network service 110 processes the training sets. At (2), the network service 100 generates an updated machine learned algorithm based on training on the combined data set. Illustratively, the network service 110 can utilize a variety of machine learning models to generate updated machine learned algorithms.

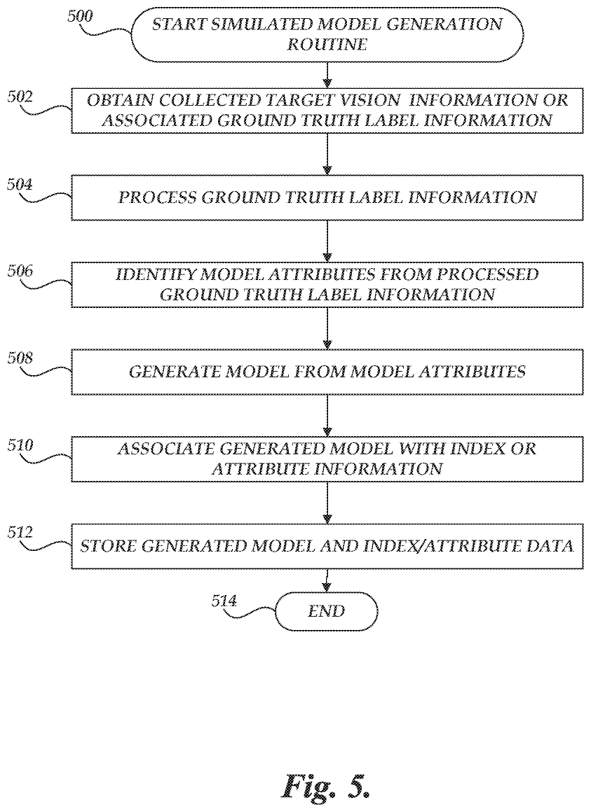

Turning now to FIG. 5, a routine 500 for processing collected vision and simulated content system data will be described. Routine 500 is illustratively implemented by the simulated content service 122. As described above, routine 500 may be implemented after the target vehicle(s) 102 including vision system data and ground truth label data for the captured vision system data is available for processing. Illustratively, the vehicles 102 may be configured to collect vision system data and transmit the collected data and associated ground truth labels. For example, the collected vision system data may be transmitted based on periodic timeframes or various collection/transmission criteria. Still further, in some embodiments, the vehicles 102 may also be configured to identify specific scenarios or locations, such as via geographic coordinates or other identifiers, that will result in the collection and transmission of the collected data. As described above, the vehicles 102 may include processing capabilities in vision systems to generate, at least in part, ground truth label information for the captured vision system information. In other embodiments, the vehicles 102 may transmit captured vision system information (with or without any ground truth labels) to another service, such as in the network 110. The additional services can then add (manually or automatically) ground truth label information. Accordingly, as previously illustrated in FIG. 4A, the collected vision system data may be transmitted to the simulated content service 122 directly from the vehicle 102 or indirectly through the network service 110.

At block 502, the simulated content service 122 receives and processes the collected vision system data and ground truth label information from the vehicles 102 (directly or indirectly). Illustratively, the simulated content service 122 can process the vision-based data, such as to complete lost frames of video data, update version information, error correction, and the like.

At block 504, the simulated content service 122 can optionally process the collected vision system data to identify ground truth labels for the captured video data. In other embodiments, the simulated content service 122 can request or otherwise obtain missing or erroneous ground truth label information from additional sources. In still other embodiments, the simulated content service 122 can obtain just ground truth label information without any associated captured vision system data. Illustratively, the ground truth labels can correspond to any one of a variety of detectable objects that may be depicted in the video data. In one embodiment, the ground truth label data can include information identifying road edges. Additionally, the ground truth label data can include information dependent on the identified road edge, such as lane lines, road centers and one or more stationary objects (e.g., road signs, markers, etc.). Still further, in some embodiments, the ground truth label data can include dynamic object data related to one or more identified objects, such as vehicles, dynamic obstructions, environmental objects, and the like.

At block 506, the simulated content service 122 can process the ground truth label data to identify the model attributes that will form the basis of the simulated content. Illustratively, the simulated content service 122 can process the ground truth label according to a priority for identifying/extracting the core ground truth label data that will be used as the basis for the simulated content. Illustratively, the lane edge ground truth labels may be considered to have a high or higher priority. Additional ground truth label data, such as lane lines labels, lane center labels, static object labels, or dynamic object labels, may be associated with low or lower priority with regard to the lane label data or relative to each other. In some embodiments, the label data may be filtered to remove one or more labels (e.g., dynamic objects) that may be replaced by the simulated content or otherwise not required to generate simulated content. For purposes of illustrated, the processed set of ground truth label may be considered the content model attributes that will for the simulated content. Still further, in other embodiments, the simulated content service 122 can utilize pre-configured or templates of standardized ground truth label based on characteristics of the simulated content to be formed. For example, simulated content for vision information captured in an urban environment (e.g., business district) can utilize a template of stationary objects, buildings, signage, traffic lights, etc. that may be considered to be generically present in such a business district.

At block 508, the simulated content service 122 generates the model for future generation of the simulated content. Illustratively, the simulated content service 122 can process the collected ground truth label data and prepare the set of ground truth labels for generating variations to form the set of simulated content as described herein. Such processing can include modifications for At block 510, the simulated content service 122 can generate index data or attribute data (e.g., metadata) for each clip or simulated content data that will facilitate selection, sorting or maintenance of the data. The index or attribute data can include identification of the location, the types of objects simulated, the number of variations that are generated/available, environmental conditions simulated, tracking information, origin source information, and the like. At block 512, the simulated content service 122 stores the generated content model attributes and identified index and model attributes. Routine 500 terminates at block 514.

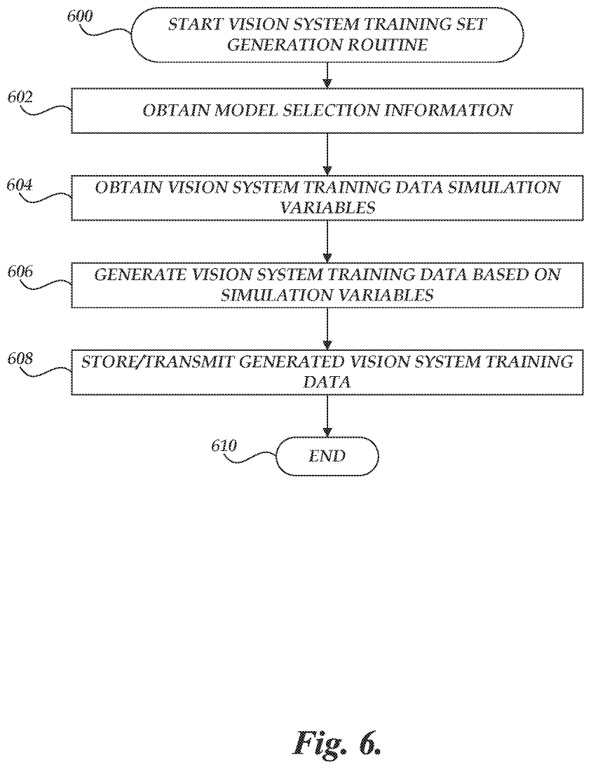

Turning now to FIG. 6, a routine 600 for generating updated machine learned algorithms using collected vision and simulated content system data will be described. Routine 600 is illustratively implemented by the simulated content service 122. At block 602, the simulated content service 122 can receive a selection or criteria for selecting the data. Illustratively, a computing device 104 may be utilized to provide criteria, such as sorting criteria. In some embodiments, the request for the simulated content is utilized to provide attributes of the simulated content. Accordingly, the generation of the simulated content can be considered to be responsive to the requests for simulated content in generating the simulated content itself. Thus, the generation of the simulated content may be considered synchronous in nature or dependent in nature. In other embodiments, the request may be a simple selectin of the index values or attributes such that the simulated content service 122 can generate the simulated content based on pre-configure attributes or configurations that are not dependent with the individual requests for simulated content. Accordingly, generation of the simulated content may be considered independent relative to the request.

At block 604, the simulated content service 122 then process the requests and identifies the generated simulated content models, such as via index data. The simulated content service 112 can then identify the attributes or variables that will be used to generate the set of simulated content. Illustratively, the simulated content system 120 can utilize a set of variables or attributes that can be changed to create different scenarios or scenes for use as supplemental content. For example, the simulated content system 120 can utilize color attributes, types of object attributes, acceleration attributes, action attributes, time of data attributes, location/position attributes, weather condition attributes, and density of vehicle attributes to create various scenarios related to an identified object. Illustratively, the supplemental content can be utilized to emulate real-world scenarios that may be less likely to occur or be measured by the set of vehicles 102. For example, the supplemental content can emulate various scenarios that would correspond to unsafe or hazardous conditions.

The simulated content system 120 may illustratively utilize a statistical selection of scenarios to avoid repetition based on trivial differences (e.g., similar scenarios varying only by color of object) that would otherwise have a potential to bias a machine learning algorithm. Additionally, the simulated content system simulated content service 122 to the number of supplemental content frames and distribution of differences in one or more variables. Illustratively, the output from the simulated content service 122 can include labels (e.g., ground truth information) identifying one or more attributes (e.g., position, velocity and acceleration) that can be detected or processed by the network service 110. In this regard, the simulated content data sets can facilitate detailed labels and can be dynamically adjusted as required for different machine learned training sets.

At block 606, the simulated content service 122 generates supplemental video image data and associated attribute data. At block 608, the simulated content training sets are transmitted to the network service 110. In some embodiments, the simulated content service 122 may store the training set or transmit based on specific criteria or subject to request. At block 610, the routine 600 terminates. For purposes of illustrative benefit, the simulated content system 122 can generate training sets for training machine learned algorithms in a manner that is highly efficient and requires significantly less time than traditional methodologies of forming training set data solely from captured vision information or by manually creating simulated content. This generates significant benefit and increased performance of the machine learned algorithms that can be continuously optimized based on any number of criteria determined or provided to the simulated content service 122.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed decision and control algorithms. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer those two elements are directly connected to each other.

Additionally, all numerical terms, such as, but not limited to, “first”, “second”, “third”, “primary”, “secondary”, “main” or any other ordinary and/or numerical terms, should also betaken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed:

1. A system for managing vision systems in vehicles, the system comprising:
a plurality of vehicles including systems for generating and processing vision data captured from one or more vision systems according to at least one machine learned algorithm, wherein the vision data captured from one or more vision systems is associated with ground truth labels;
one or more computing systems including processing devices and memory, that execute computer-executable instructions, for implementing a vision system information processing component that is operative to generate the at least one machine learned algorithm for execution by the plurality of vehicles, the at least one machine learned algorithm generated from a set training data; and
one or more computing systems including processing devices and memory, that execute computer-executable instructions, for implementing a simulated content generation service operative to:
obtain ground truth label data associated with collected vision data from one or more of the plurality of vehicles;
process the obtained ground truth label data associated with the collected vision data to forming selected ground truth label data for use in generating a content model, wherein the formation of the selected ground truth label data is based on an ordered priority of content model attributes to generate simulated model content;
associate at least one of index data or content model attribute data based on the generated simulated model content; and
store the generated simulated model content and the at least one of index data and content model attribute data.

2. The system as recited in claim 1, wherein the formation of the selected ground truth label data includes identifying ground truth label data corresponding to road edges.

3. The system as recited in claim 2, wherein the formation of the selected ground truth label data includes subsequent identifying ground truth label data corresponding to at one static object based on identified road edges.

4. The system as recited in claim 3, wherein the static object corresponds to lane lines based on the identified road edges.

5. The system as recited in claim 3, wherein the static object corresponds to lane center based on the identified road edges.

6. The system as recited in claim 3, wherein the static object corresponds to stationary objects based on the identified road edges.

7. The system as recited in claim 2, the formation of the selected ground truth label data includes subsequent identifying ground truth label data corresponding to at least one dynamic object based on identified road edges.

8. The system as recited in claim 1, wherein the simulated content generation service filters at least one ground truth label from the obtained ground truth label data.

9. The system as recited in claim 1, wherein the index data corresponds to geo hash information.

10. The system as recited in claim 1, the formation of the selected ground truth label data includes including at least one additional ground truth label, wherein the at least one additional ground truth label is based on a selected template. to.

11. A method for managing vision systems in vehicles, the system comprising:
obtaining ground truth label data associated with collected vision data, the collected vision data corresponding to vision systems on a vehicle;
identifying one or more content model attributes based on the obtained ground truth label data;
generating simulated model content based on a subset of the content model attributes; and
storing the generated simulated model content.

12. The method as recited in claim 11 further comprising processing the one or more content model attributes based on an ordered priority of content model attributes to identify the subset of the content model attributes.

13. The method as recited in claim 11 further comprising associating at least one of index data or content model attribute data based on the generated simulated model content.

14. The method as recited in claim 13, wherein the index data corresponds to geo hash information.

15. The method as recited in claim 11, wherein the content model attribute data is associated with at least one static object depicted in the simulated content.

16. The method as recited in claim 11, wherein identifying one or more content model attributes based on the obtained ground truth label data includes identifying at least road edges in identifying the one or more content model attributes.

17. The method as recited in claim 16, wherein identifying one or more content model attributes based on the obtained ground truth label data includes subsequently identifying at one static object based on identified road edges.

18. The method as recited in claim 17, wherein the static object corresponds to at least one of lane lines based on the identified road edges, lane center based on the identified road edges, or stationary objects based on the identified road edges.

19. The method as recited in claim 16, wherein identifying one or more content model attributes based on the obtained ground truth label data supplementing at least one ground truth label based on a pre-configuration of ground truth labels.

20. A method for managing vision systems in vehicles, the system comprising:
obtaining generated ground truth label data associated with collected vision data, the collected vision data associated with visions systems on vehicles;
processing the obtained ground truth label data associated with the collected vision data to form a first set of ground truth label data for use in generating a content model;
further processing the ground truth label data associated with the collected vision data to form additional ground truth label data for use in generating a content model, wherein the additional ground truth label data is dependent on the first set of ground truth label data;
generating simulated model content based on the first and second sets of ground truth label data; and
storing the generated simulated model content.

21. The method as recited in claim 20 further comprising associating at least one of index data or content model attribute data based on the generated simulated model content.

22. The method as recited in claim 20, wherein the first set of ground truth data includes at least road edges in identifying the one or more content model attributes.

23. The method as recited in claim 20, wherein the second set of ground truth data includes at least one static object based on the first set of ground truth data.

24. The method as recited in claim 23, wherein the static object corresponds to at least one of lane lines based on the identified road edges, lane center based on the identified road edges, or stationary objects based on the identified road edges.

25. The method as recited in claim 23 further comprising further processing the ground truth label data associated with the collected vision data to form second additional ground truth label data for use in generating a content model, wherein the second additional ground truth label data is based on at least one of a template or pre-configured selection of ground truth label data.
